(19) United States
(12) Patent Application Publication
(10) Pub. No.: US 2002/0066039 A1
(43) Pub. Date: May 30, 2002

(54) Anti-spoofing password protection

(76) Inventor: Paul W. Dent, Pittsboro, NC (US)

Correspondence Address: COATS & BENNETT, PLLC, P O BOX 5, RALEIGH, NC, 27602, US

(21) Appl. No.: 09/727,062

(22) Filed: Nov. 30, 2000

(51) Int. Cl. H04L 9/32

(52) U.S. Cl. 713/202

(57) ABSTRACT

A system and method to prevent the inadvertent disclosure of a password. A valid password input request results in a password entry screen being displayed to a user that includes authentication indicia known to the user. Failure to see the authentication indicia causes the user to know that the request is a spoof. The invention may further include a method and system of limiting the applications that operate after a password input request is received. Only the applications necessary for inputting the password operate, as the other applications are set as inoperable until the password has been input. This prevents a remote source from obtaining the password through fraudulent means such as a screen capture or trojan horse program.

### BACKGROUND OF THE INVENTION

The present invention relates to a method and system of password protection, and particularly, to a method of protecting a password from inadvertent or unintentional disclosure to a fraudulent party.

Password protection is commonly used to protect files and to prevent unauthorized use of secured devices. With password protection, a user enters a predetermined password in order to gain access to the protected file or to enable use of the secured device. Anyone with knowledge of the password may gain access to the protected file or device. Therefore, it is important to keep passwords secret in order to maintain privacy and prevent fraudulent activities.

The evolving business of Internet trade or e-commerce, which can include the use of wireless devices, may employ encryption techniques and authentication methods as part of a comprehensive system of fraud prevention and privacy protection. Wireless devices have long incorporated security features. For example, mobile terminals conforming to the Global System for Mobile Communications (GSM) standard employ removable smart cards that authenticate the user's identity for billing purposes. These smart cards generate temporary encryption keys that are used to encrypt and decrypt sensitive communications. Some issuers of smart cards, such as Sweden's Telia, also use subscriber-entered passwords, such as a PIN code, to activate the smart card in order to protect against fraudulent use of a lost card. In the past, the smart card typically stores the expected password. The smart card is supposed to be tamper-proof, making it difficult to extract the password.

A related United States patent application entitled “Secure Storage of Ciphering Information Using a PIN Code”, which is being simultaneously filed with this application, discloses a smart card that uses a private key modified in dependence on a user-entered PIN code. For example, the PIN code may comprise selected digits deliberately omitted from the private key. Once the private key is modified, the PIN code is deleted. An entered password may then be verified by enciphering a random bitstring with the regenerated private key and then deciphering the result with a corresponding public key. If the random bitstring is not reproduced, the entered code is false. Trying all possible passwords until one works is inhibited by allowing only a limited number of failures in succession before the device enters a locked state.

### BRIEF SUMMARY OF THE INVENTION

The present invention is directed to a system and method of preventing the inadvertent release of a confidential password to a foreign party. The user obtains a confidential password and confidential authentication indicia, either of which may be determined by the user or assigned to the user. When a function requiring the password is invoked, a password entry screen is displayed for entering the password. A valid password entry screen displays the authentication indicia to indicate to the user that the password request is authentic. Absence of the authentication indicia indicates that the password entry screen is a spoof.

### BRIEF DESCRIPTION OF THE DRAWINGS

FIG. 1 is a block diagram of a user device that uses the password protection method of the present invention.

FIG. 2 is a block diagram of a security module for the user device of FIG. 1.

FIG. 3 is an illustration of an exemplary password entry screen invoked by the security module.

FIG. 4 is a flow diagram illustrating an exemplary method of initializing the security module to use the password protection method of the present invention.

FIG. 5 is a flow diagram of a password program executed by the security module.

### DETAILED DESCRIPTION OF THE INVENTION

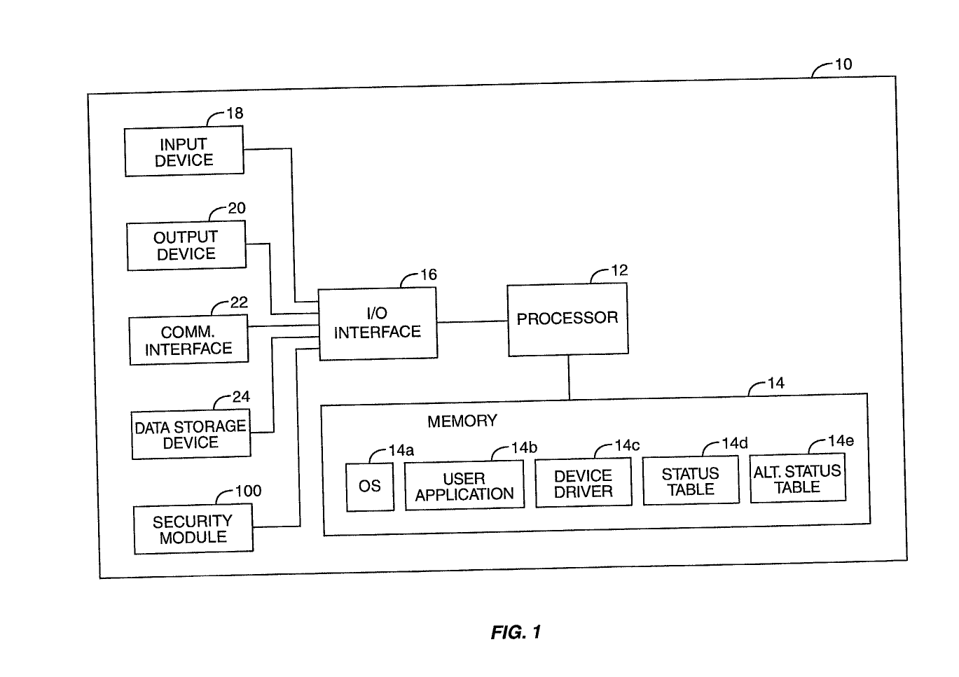

FIG. 1 illustrates a schematic representation of a host device 10 that implements a password protection method according to the present invention. Host device 10 may comprise a variety of computing devices. For example, host device 10 may comprise a computer, such as a desktop computer, laptop computer, or palm-top computer. Host device may, alternatively, comprise a mobile communication device with a processor, such as a cellular radiotelephone, Personal Communications System (PCS) terminal, or personal digital assistant (PDA).

The exemplary host device 10 shown in FIG. 1 comprises a main processor 12, memory 14, I/O interface 16, input device 18, output device 20, communications interface 22, data storage device 24, and security module 100. Those skilled in the art will recognize that all of these elements are not required and that other configurations of a host device 10 can use the password protection method described herein.

Processor 12 controls the operation of the host device 10 according to programs stored in memory 14. Processor 12 also runs installed user applications. Processor 12 may comprise a single processor or, alternatively, processing functions may be distributed over multiple processors.

Memory 14 represents the entire hierarchy of memory in a computing device and may comprise read-only memory (ROM), programmable read-only memory (PROM), erasable programmable read-only memory (EPROM), flash memory, and random access memory (RAM). Memory 14 stores the operating system (OS) programs 14a, user applications 14b, and device drivers 14c that control operation of the device 10. Memory 14 also stores temporary data, such as status tables 14d and 14e, used by the OS and application programs 14a and 14b. The status tables 14d and 14e, which are typically stored in RAM, indicate the status of currently executing applications, as will be hereinafter described.

Input/output (I/O) interface 16 connects processor 12 with the input device 18, display 20, external communications interface 22, data storage device 24, and security module 100. Input device 18 and output device 20 provide means for the user to interact with the host device 10. Input device 18 may, for example, comprise a keyboard, keypad, mouse, trackball, digitizer tablet, light pen, touchpad, voice detection module, or a combination of such devices. Using input device 10, the user inputs data and commands into the host device 10. Output device 20 comprises any device for outputting information to a user. The output device 20 may, for example, a cathode ray tube (CRT) display, or liquid crystal display (LCD). Other output devices, such as a printer or voice synthesizer, could be used in addition to or in lieu of a display.

External communications interface 22 connects the host device 10 to external devices or networks and may, for example, comprise an Ethernet interface, serial interface, modem, radiotelephone transceiver, or any other interface typically used to communicate with other devices.

Removable data storage device 24 is a device for reading data from and/or writing data to a removable data storage media, such as a floppy disk or flash memory card. Removable data storage device 24 may, for example, comprise a floppy disk drive, ZIP® drive, flash memory drive, or magnetic card reader. Removable data storage device 24 may, alternatively, be replaced by an interface for connecting an external data storage device 24.

Security module 100 is a secure device, such as a tamper-proof chip, that performs various security functions. The security module 100 could also comprise a removable smart card that inserts into or connects with the removable data storage device 24 or interface. The security functions performed by security module 100 may include one or more of the following services: encryption and decryption of data, authentication of user identities, key generation and management, password authentication, and data integrity verification. Security module 100 may perform other security functions in addition to those listed above. In the exemplary embodiment described herein, the user must enter a valid password to perform one or more of these security functions.

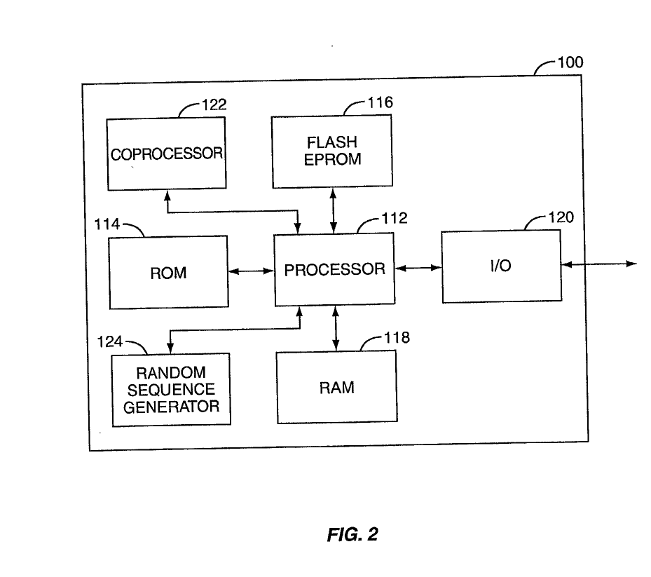

FIG. 2 illustrates one embodiment of a security module 100. The security module 100 may be used to store user identification data or other authentication data and to perform a variety of security functions. Security module 100 may also store variables used for encrypting and decrypting communications, such as a public/private key pair and identity certificate. In one embodiment, security module 100 is in the form of a smart card about the size of a credit card (about 3″×5″) such that it can be easily carried by the user. The exemplary embodiment of the security module 100, shown in FIG. 2, comprises a secure processor 112, read-only memory (ROM) 114, erasable programmable read-only (EPROM) 116, random access memory (RAM) 118, input/output (I/O) interface 120, co-processor 122, and random sequence generator 124.

Secure processor 112 executes programs stored in read-only memory 114 and responds to digital codes presented to the secure processor 112 on I/O interface 120. One program executed by secure processor 112 is a password program for obtaining a password from a user. Security programs may also be executed by secure processor 112 to perform a variety of security functions, such as encryption and decryption of data. The digital codes presented to the secure processor 112 represent commands to be executed by the secure processor 112. There are only a limited set of valid commands that may be executed by the secure processor 112. Valid commands include, for example, requests to encipher or decipher data presented on the I/O interface 120 and to return the result as output bits on the I/O interface 120. Encryption and decryption may be performed using internally stored or externally supplied keys. When encryption is performed using a stored, long-term secret key, such as the private key of a public/private key pair, it is generally desirable that the encryption operation be performed internally by the secure processor 112 and one or more co-processors 122 in order to obviate the need for the secret key to be output to an external or off-chip device. In that case, there will be no legal command to request output of the private key to which the secure processor 112 will respond. Thus, there may be, if necessary, a co-processor 122 to accelerate computations of the sort necessary using public key encryption methods based on very large prime numbers.

Read-only memory 114 stores programs that are executed by secure processor 112 and its co-processors 122, if present. The programs stored in read-only memory 114 determine the legal commands recognized by secure processor 112. Read-only memory 114 is, typically, factory programmed and the programs stored therein are typically unalterable to prevent tampering. One of the programs stored in ROM 114 is the password program implementing the password protection method of the present invention.

EPROM 116 stores user-specific data or other data that may be field programmed. This includes the user's identity certificate and public-key/private-key pair and the associated encryption modulus. The public key may be a relatively small number in the order of one to eight decimal digits. The public key is typically published in a catalog or database along with the encryption modulus and user's identity. The encryption modulus is typically 2048 bits (256 bytes) and the private key is on the same order of word length. The public key, encryption modulus, and private key are initially stored in EPROM 116 but, during initialization, the public key and encryption modulus may be erased from memory, as will be described below. Further, the private key and/or public key may be modified during the initialization process as hereinafter described. EPROM 116 could also store authentication data used to validate passwords.

Random access memory 118 provides a working memory for storage of temporary variables and data generated during encryption, decryption, and other operations. Random access memory 118 may be internal or external to the secure processor 112.

Co-processor 122 is a specially designed processor for accelerating computations, particularly those involved in encryption and decryption operations. For example, co-processor 122 may be specially programmed to perform modulo exponentiation, factoring, or other mathematical computations.

Random sequence generator 124 generates a random bit sequence used by the secure processor 112 to compute encryption variables. Random sequence generator 124 may, for example, be a random noise generator.

The security module 100 may perform a variety of security functions. The functions performed by the security module 100 may, for example, include encryption and decryption of data, authentication, verification of data integrity, key generation and management, and password authentication. To access one or more of these functions, the user may be required to enter a password. For example, the user's password may be needed in order to regenerate the public and private keys used for encryption and decryption operations as hereinafter described.

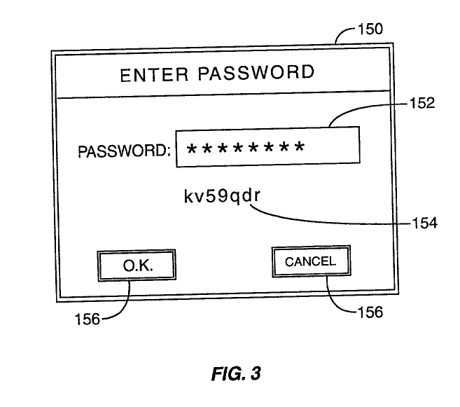

The security module 100 causes a password entry screen to be displayed whenever the user attempts to access a function or service requiring a password. An exemplary password entry screen is shown in FIG. 3 and is indicated generally by the numeral 150. The password entry screen 150 includes a data entry field 152, such as a text box, where the user inputs the password. The password entry screen 150 may also include explanatory text, such as headings and instructions. The password entry screen 150 may further include buttons 156 activated by the user to either proceed or cancel the operation.

If the format of the password entry screen 150 is generally known or is discoverable, it is possible for a party with fraudulent or malicious intent to create a spoof password entry screen that mimics the authentic password entry screen 150. If the user is lured to enter his password into a spoof password entry screen, a program associated with the spoof password entry screen may capture the entered password and forward the entered password to the fraudulent party.

To prevent spoofing, the password entry screen 150 according to the present invention further includes authentication indicia, also referred to herein as reverse password 154, which is not known and which is not discoverable by a party intent on fraud. A valid password entry screen 150 would always include the reverse password 154. Therefore, the absence of the reverse password 154 on the password entry screen 150 serves to alert the user that the displayed password entry screen 150 may not be authentic. In that case, the user may elect to cancel the operation rather than enter the password.

In one embodiment of the invention, the user's password and reverse password 154 are entered during an initialization procedure to configure the security module 100. It is not necessary that the password and reverse password 154 be entered at the same time, but that will typically be the case. Access to security functions performed by the security module 100 may be denied until the reverse password 154 is entered to ensure that this security measure is not circumvented. The password entered by the user may be used to modify data stored in the security module 100, such as the public and private key of the user. The password may then be erased. Erasure of the password, however, is not required to practice the invention.

The reverse password 154, and possibly the user's password, are stored within the secure confines of the security module 100, such as in flash EPROM 116. Thereafter, when the security module 100 causes the password entry screen 150 to be displayed, the reverse password 154 stored in flash EPROM 116 is retrieved from memory and displayed on the password entry screen 150 as shown in FIG. 3. There are no valid commands which will cause the security module 100 to output the reverse password 154. Therefore, a party intent on fraud will not have access to the reverse password 154 unless that person is in a position to visually observe the password entry screen 150. It is assumed that the user will take measures to ensure that he or she is not being visually observed by a party intent on fraud while the password entry screen 150 is displayed.

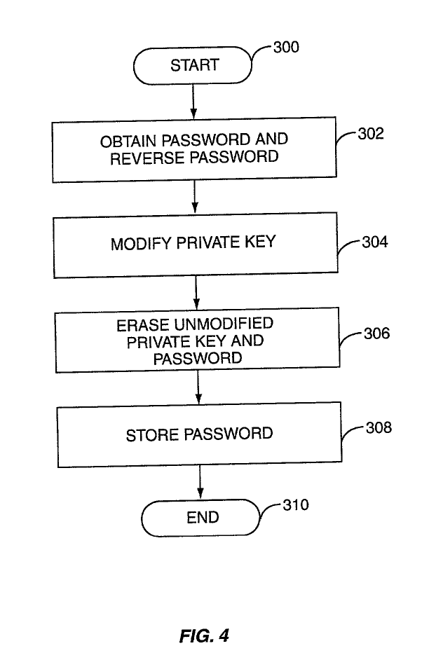

FIG. 4 is a flow diagram illustrating an exemplary initialization procedure for initializing the security module 100. The initialization procedure incorporates the anti-spoofing password protection scheme of the present invention. The initialization procedure is stored in read-only memory 114. The initialization procedure begins at step 300.

At step 302, processor 112 prompts the user to enter a password and to input or select a reverse password 154 via input device 18 (step 304). The password may be used, for example, to modify a private key, as will be described below. The private key may be generated internally or may be supplied to the security module 100 from an outside source. The reverse password 154 may be of any length, and contain any variety of characters. The reverse password 154 may also comprise a graphic image which the user selects.

In an alternative embodiment, the password and reverse password 154 may be pre-programmed in the security module 100 during production and stored within ROM 114. In either alternative, the user should be able to recognize the reverse password 154 and understand its significance when it appears on the password entry screen 150 to ensure the password input request is valid.

Upon receipt of the password from the user, secure processor 112 modifies the user's private key in dependence on the user-selected password (step 304). The private key may be modified in several ways. For example, the private key could be modified by eliminating random digits in dependence on the user's password. The modified private key, for example, may have some missing digits which have to be filled in by the user to complete the private key. For example, two bytes of the private key could be left blank and the missing 16 bits grouped to form a 4-digit, hexadecimal PIN code, e.g., 5C1F. In this example, the modified private key stored in memory is deficient in the number of digits.

In another implementation, the password may be any arbitrary character string of any length that the user can remember. The character string is then used to generate a key modifier having a length equal to the length of the private key. The key modifier can be generated, for example, by hashing the password with a one-way hashing function, such as SHA-1, to obtain the modifier. Alternatively, the password could be encrypted using the public key to obtain a bitstring of equal length to the encryption modulus, which is at least as long as the private key. Bits from the encrypted password could then be selected to form the modifier. The key modifier is used to modify the private key, for example, by modulo-2 addition of the modifier with the bits of the private key. Any other modification operation could alternatively be used, such as long integer addition or bytewise modulo-256 addition, as long as the secure processor 112 can perform the inverse operation. Modulo-2 bitwise addition, however, is simple to implement since addition and subtraction are the same operation and no carries are involved.

Following modification of the private key, secure processor 112 erases the unmodified private key and password from memory, as well as any products used to compute the public and private keys (step 306). The reverse password is stored in EPROM 116 where it can be later accessed by the secure processor 112 (step 308) and the initialization procedure ends (step 310).

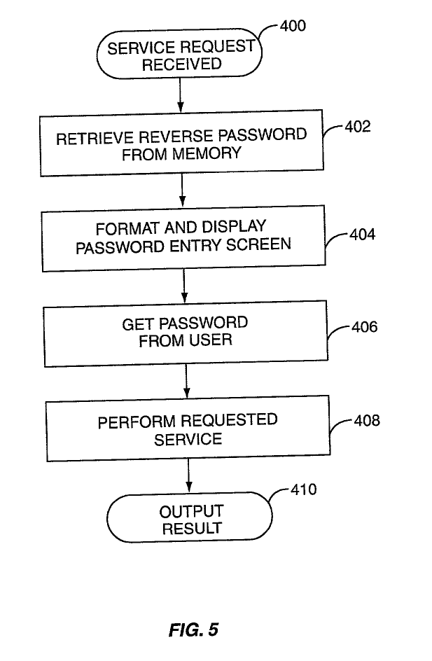

The security module 100 in the exemplary embodiment described above may be used for a variety of security functions, such as encrypting and decrypting communications with a second party. For example, the security module 100 may be used to send and receive encrypted communications to and from a second party via an insecure network, such as the Internet. By way of example, the security module 100 may be used to engage in commercial or financial transactions with a second party which require that communications be encrypted. Encryption and decryption are security functions performed by the security module 100. Access to these security functions in the exemplary embodiment requires entry of a valid password by the user so that the private key can be regenerated. Thus, whenever a user attempts to engage in encrypted communication with a second party, the secure processor 112 causes the password entry screen 150 of FIG. 3 to be displayed. This process is shown in FIG. 5.

At step 400, the security module 100 receives a service request from the user or an application running on the host device 10 requiring the user's password. The service request in this example comprises a request to encrypt or decrypt data. The security module 100 retrieves the reverse password 154 from memory at step 402 and then formats and displays the password entry screen 150 at step 404.

The password entry screen 150 presented on the display 20 includes the reverse password 154 which verifies to the user that the password entry screen 150 is valid and is not a spoof or fraudulent attempt to get the user's password. The reverse password 154 may be permanently displayed on the password entry screen 150 for as long as the password entry screen 150 is visible, or may be visible for only a limited duration to prevent someone from seeing it and including it in a spoof password entry screen. The user enters the password (step 406). If the password is valid, the security module 100 provides the requested service (step 408) and returns the result on the I/O interface 120 (step 410).

The present invention prevents fraudulent parties from spoofing the user into inadvertently disclosing the password. Although the fraudulent party may be aware of the aesthetic appearance of the password entry screen 150, the reverse password 154 is confidentially maintained separate from the password input program. Therefore, the user who sees a password entry screen 150 without the appearance of the reverse password 154 would be alerted that this is not a legitimate password request and could elect to cancel the operation.

To further improve security, the security module 100 should not be linked into the host processor 12 via normal operating system calls that can be accessed by any program, nor should any display, including the password entry screen 150, generated by the security module 100 be capable of being redirected to any destination other than the local display 20. Further, the security module 100, whenever the password entry screen 150 is displayed, or whenever any other secret or private information is displayed, should be capable of inhibiting the launch or execution of other programs, such as a screen image capture program, by the operating system. Processor cycles should be restored to other programs only after the secret display has ceased to be on the screen. This may be accomplished by a security lock program executed by the secure processor 112 in security module 100.

A variety of techniques may be used to stop or freeze other application programs while secret information is displayed. For example, the security lock program may inhibit all processor interrupts, except the keyboard and display interrupt responding to a request by the security module 100. Alternatively, the security lock program could “freeze” other applications. One way to “freeze” other applications is to prevent context-switching by the operating system 14a during security operations except to keyboard and display device drivers for the purpose of servicing a call by the security module 100. Freezing other applications can also be accomplished by manipulating settings in a status table 14d used by the operating system 14a, or by directing the operating system 14a to use an alternative status table 14e. Status table 14d contains a listing of each application stored within memory 14 and includes an indication of the status of each application. The operating system 14a, in response to instructions from the security module 100, saves the settings of the status table 14d and shuts down any application that is not necessary for the entry of the password. By way of example, if only the display driver and input device driver are needed to display the password entry screen 150 on the display 20 and accept input from the input device 18, all other applications and device drivers are suspended. Once the password has been input and the password entry screen 150 removed from the display 20, the operating system 14a restores the applications in accordance with the saved status table settings. This procedure prevents the password entry screen 150 generated by the password input program from being redirected to any destination other than the local display 20. Additionally, the security module 100 prohibits the launch or execution of other programs, such as a screen image capture program, when secret information is displayed.

Another method of maintaining security is for an alternative status table 14e to be stored within memory 14. The alternative status table 14e includes the applications necessary for the password input program. At the time the password entry screen 150 is displayed, operating system 14a is directed to access only the applications indicated within the alternative status table 14e and saves the settings indicated by status table 14d. Once the password process is complete, operating system 14a is directed to reactivate the applications indicated by status table 14d. Therefore, during password entry, if a fraudulent request to save the screen and send it to a foreign source is received, processor 12 cannot comply with the request as this would require applications other than those indicated by the alternative status table 14e. The applications indicated by status table 14d at the time the request was received are only re-authorized after entry of the password.

Another method of maintaining security comprises using a status flag in the status table 14d to indicate the status of each resident application. The status flag may be temporarily saved and overwritten by a flag indicating that the program is in the inactive or “killed” state during password entry. After completion of the password entry, the original status flag value may be restored.

The present invention may, of course, be carried out in other specific ways than those herein set forth without departing from the scope and essential characteristics of the invention. By way of example, the password input program may be saved either within the device or the smart card depending upon the specific application. The present embodiments are, therefore, to be considered in all respects as illustrative and not restrictive, and all changes coming within the meaning and equivalency range of the appended claims are intended to be embraced therein.

What is claimed is:

1. A method implemented in a computing device of obtaining a password from a user, said method comprising:
storing authentication indicia recognized by said user in said computing device; and
prompting a user to enter said password by displaying a password entry screen containing said authentication indicia.

2. The method of claim 1 wherein storing authentication indicia recognized by said user in said computing device comprises storing said authentication indicia in a security module.

3. The method of claim 1 wherein displaying said password entry screen containing said authentication indicia comprises displaying said authentication indicia for a limited time.

4. The method of claim 1 further comprising obtaining said authentication indicia from said user.

5. The method of claim 1 further comprising halting programs running on said computing device not necessary for inputting said password while said password entry screen is displayed.

6. A method implemented by a security module in a computing device of obtaining a password from a user, said method comprising:
prompting a user to enter said password by displaying a password entry screen;
halting programs not needed by said security module while said password entry screen is displayed;
obtaining said password from said user;
removing said password entry screen from said display; and
restarting halted programs after said password entry screen is removed from said display.

7. The method of claim 6 wherein halting programs not needed by said security module while said password entry screen is displayed comprises inhibiting an operating system in said computing device from responding to interrupts not associated with said security module.

8. The method of claim 6 wherein halting programs not needed by said security module while said password entry screen is displayed comprises inhibiting context-switching by an operating system in said computing device to programs not needed by said security module.

9. The method of claim 6 wherein halting programs not needed by said security module while said password entry screen is displayed comprises:
storing a status table in random access memory used by an operating system in said computing device, each entry in said status table relating to a currently executing program and containing a status indication associated with said currently executing program;
saving current settings of said status table; and
changing said current settings so as to inhibit execution by said operating system of said programs not needed by said security module.

10. The method of claim 6 wherein halting programs not needed by said security module while said password entry screen is displayed comprises:
storing an alternate status table in random access memory used by an operating system in said computing device, each entry in said alternate status table relating to a program needed by said security module;
instructing said operating system to use said alternate status table while said password entry screen is displayed.

11. A device for inputting a confidential password comprising:
a secure processor executing a password program to obtain a password from a user;
memory operatively connected to said secure processor storing authentication indicia recognized by a user of said device;
a display operatively connected to said secure processor to display a password entry screen containing said authentication indicia.

12. The device of claim 11 further comprising a smart card containing said secure processor and said memory.

13. The device of claim 11 further comprising a security lock program executed by said secure processor to inhibit execution of programs not needed by said secure processor to obtain said password from said user.

14. The device of claim 13 wherein said security lock program inhibits an operating system from responding to interrupts not associated with said secure processor while said password entry screen is displayed.

15. The device of claim 13 wherein said security lock program inhibits an operating system from context-switching while said password entry screen is displayed.

16. The device of claim 13 wherein said security lock program inhibits execution of programs not needed by said secure processor to obtain said password from said user.

17. The device of claim 16 wherein said security lock program inhibits execution of programs not needed by said secure processor to obtain said password from said user by changing settings in a status table used by an operating system while said password entry screen is displayed.

18. The device of claim 16 wherein said security lock program inhibits execution of programs not needed by said secure processor to obtain said password from said user by causing an operating system to use an alternate status table while said password entry screen is displayed.

19. A device for a performing secure transactions, said device comprising:
memory storing authentication indicia recognized by a user of said device;
a secure processor programmed to:
prompt said user to enter a password by displaying a password entry screen containing said authentication indicia; and
perform said secure transaction following entry of said password by said user.
